(19) United States
(12) Patent Application Publication
(10) Pub. No.: US 2009/0302167 A1
(43) Pub. Date: Dec. 10, 2009

(54) Apparatus and method for use on aircraft with spanwise flow inhibitors

(76) Inventor: Robert J. Desroche, Everett, WA (US)

Correspondence Address: SEED INTELLECTUAL PROPERTY LAW GROUP PLLC, 701 FIFTH AVE, SUITE 5400, SEATTLE, WA, 98104, US

(21) Appl. No.: 11/509,326

(22) Filed: Aug. 23, 2006

(51) Int. Cl. B64C 3/58; B23P 11/00

(52) U.S. Cl. 244/199.4; 244/198; 29/428

(57) ABSTRACT

An aircraft can include a wing with a leading edge and a trailing edge. The wing has a main body and movable control surfaces coupled to the main body. The wing generates lifting forces when the aircraft is in flight. The movable control surfaces can be used to control the generated lifting forces. A spanwise flow inhibitor extends from the outer wingtip of the wing. At least one gurney flap extends generally downwardly from at least a portion of the trailing edge of the wing. The flap at least partially counteracts a change in center of lift attributable to the spanwise flow inhibitor.

### BACKGROUND OF THE INVENTION

1. Field of the Invention

The present disclosure in some embodiments generally relates to aircraft, and more specifically to aircraft with at least one gurney flap.

2. Description of the Related Art

Aircraft, such as airplanes, often have wingtip fences, commonly referred to as winglets. The wingtip fences typically extend generally vertically from the wingtips of the aircraft. These wingtip fences may increase the effective aspect ratio of the wing. Wingtip fences may reduce induced drag associated with wingtip vortices to improve fuel efficiency, increase cruising speed, improving handling characteristics, and provide a modern appearance often desirable for aircraft.

Wingtip fences typically move the center of lift outwardly towards the wingtip, thus increasing wing bending moments during flight. This increased bending moment may induce fatigue in the wing structure or wing box, and, consequently, requires increased frequency of inspections and routine maintenance.

### BRIEF SUMMARY OF THE INVENTION

Some embodiments disclosed herein include the realization that wings can have one or more gurney flaps to counteract the increase in bending moment induced by wing extensions (e.g., wing tip extensions), spanwise flow inhibitors (e.g., wingtip fences, winglets, endplates, and the like), payload increases, and the like. The gurney flaps can extend from the wing proximate or at the trailing edge thereof. The gurney flaps can be fixed to a movable control surface or fixed to a stationary portion of the wing. The gurney flaps may reduce stresses in the wing, thereby improving fatigue performance and reducing the frequency of inspections and routine maintenance. The combination of spanwise flow inhibitors and gurney flaps can improve aircraft performance by, for example, reducing induced drag, increasing cruising speeds, improving fatigue performance and handling characteristics. The spanwise flow inhibitors, such as winglets, can provide a modern appearance, even if installed on older aircraft.

In some embodiments, a wing includes two or more control surfaces (e.g., flaps and/or ailerons) so that each wing has an inboard control surface generally proximate the fuselage and an outboard control surface outward of the inboard control surface. One or both of these control surfaces may be provided with gurney flaps.

In other embodiments, an aircraft comprises a fuselage and a wing extending laterally outward from the fuselage. The wing has an inner portion proximate the fuselage, an outer wingtip, and at least a first selectively movable control surface spaced between the inner portion and the outer wingtip. A portion of the wing forms a leading edge between the inner portion and the outer wingtip, and a portion of the wing forms a trailing edge between the inner portion and the outer wingtip. A spanwise flow inhibitor extends at an angle from the outer wingtip of the wing. At least one gurney flap extends generally downwardly from at least a portion of the trailing edge of the wing.

In some embodiments, the gurney flap is sized, dimensioned, and positioned to at least partially counteract or offset a change in center of lift attributable to the spanwise flow inhibitor. The gurney flap can be dimensioned to generate lift on a portion of the wing between a center of lift of the wing and the fuselage when the aircraft is in flight.

In yet other embodiments, a wing for an airplane comprises a wing assembly that includes a main body and at least one selectively movable control surface. The main body has an outer wingtip, an upper surface, and a lower surface opposing the upper surface. The upper and lower surfaces are shaped and dimensioned to produce lift during flight. A spanwise flow inhibitor is coupled to the outer wingtip of the main body. At least one gurney flap fixedly extends at an angle from and longitudinally along a portion of the wing proximate the trailing edge thereof.

In some embodiments, a wing for an aircraft comprises a cambered upper surface, cambered lower surface, and at least one selectively movable control surface. A leading edge is formed between the upper and lower surfaces. A trailing edge is formed between the upper and lower surfaces. The trailing edge includes a portion of the at least one control surface. The wing also comprises an outer wingtip and a spanwise flow inhibitor extending at an angle from at least proximate the outer wingtip and means for offsetting a change in a center of lift attributable to the spanwise flow inhibitor. In some variations, the means for offsetting a change in center of light includes a gurney flap extending from proximate the trailing edge of the wing.

In some embodiments, a method of installing a gurney flap on a wing of an aircraft is provided. The method comprises determining a change in a position of a center of lift attributable to a spanwise flow inhibitor. A longitudinal position along a trailing edge of a wing is determined such that lift produced by a gurney flap counters the change in the position of the center of lift attributable to the spanwise flow inhibitor. The gurney flap is coupled to extend from a portion of the trailing edge at the determined longitudinal position.

In other embodiments, a method of installing a gurney flap on a wing of an aircraft comprises determining a change in a position of a center of lift attributable to a spanwise flow inhibitor and a position along a trailing edge of a wing such that lift produced by one or more gurney flaps counter the change in the position of the center of lift attributable to the spanwise flow inhibitor.

### BRIEF DESCRIPTION OF THE SEVERAL VIEWS OF THE DRAWINGS

in the drawings, identical reference numbers identify similar elements or acts. The sizes and relative positions of elements in the drawings are not necessarily drawn to scale. For example, the shapes of various elements and angles may not be drawn to scale, and some of these elements may be arbitrarily enlarged and positioned to improve drawing legibility.

FIG. 1 is a front elevational view of an aircraft with spanwise flow inhibitors.

FIG. 2 is a plan view of a portion of a fuselage and a right wing extending from the fuselage of the aircraft of FIG. 1.

FIG. 3 is a pictorial view of the right wing of the aircraft of FIG. 1, where gurney flaps are coupled to movable control surfaces of the wing.

FIG. 4 is a rear elevational view of a portion of the right wing of FIG. 3.

FIG. 5 is a cross-sectional view of a rearward portion of the right wing of FIG. 2 taken along line 5-5 of FIG. 2.

FIG. 6 is a cross-sectional view of the rearward portion of the right wing of FIG. 5, where a control surface is in a lowered position.

FIG. 7 is an enlarged cross-sectional view of the control surface and trailing gurney flap of FIG. 5 taken along 7-7.

FIG. 8 is a top elevational view of a gurney flap, in accordance with one illustrated embodiment.

FIG. 9 is a side elevational view of the gurney flap of FIG. 8.

FIG. 10 is a cross-sectional view of the gurney flap of FIG. 8 taken along line 10-10.

FIG. 11A is a cross-sectional view of a rearward portion of a control surface having a gurney flap, in accordance with one embodiment.

FIG. 11B is a cross-sectional view of a rearward portion of a control surface having an gurney flap, in accordance with one embodiment.

FIG. 12 is a pictorial view of a right wing with a spanwise flow inhibitor, where gurney flaps are coupled to control surfaces of the right wing, in accordance with one illustrated embodiment.

FIG. 13 is a rear elevational view of the right wing of FIG. 12.

FIG. 14A is a front elevational view of a wing with an spanwise flow inhibitor, in accordance with one illustrated embodiment.

FIG. 14B is a side elevational view of the spanwise flow inhibitor of FIG. 14A.

FIG. 15A is a perspective view of a portion of a wing with a spanwise flow inhibitor, in accordance with one illustrated embodiment.

FIG. 15B is a front elevational view of the portion of a wing with the spanwise flow inhibitor of FIG. 15A.

FIG. 15C is a side elevational view of the spanwise flow inhibitor of FIG. 15A.

FIG. 16A is a front elevational view of a portion of a wing with a spanwise flow inhibitor, in accordance with one illustrated embodiment.

FIG. 16B is a side elevational view of the spanwise flow inhibitor of FIG. 16A.

FIG. 17 is a front elevational view of a portion of a wing with a spanwise flow inhibitor, according to one illustrated embodiment.

FIG. 18A is a front elevational view of a portion of a wing with a pair of tip sails.

FIG. 18B is a side elevational view of the tip sails of FIG. 18A.

FIG. 19A is a top elevational view of a wing, in accordance with one illustrated embodiment.

FIG. 19B is a top elevational view of the wing of FIG. 19A with a spanwise flow inhibitor.

FIG. 19C is a top elevational view of the wing of FIG. 19B with gurney flaps.

FIG. 20A is a top elevational view of a wing, in accordance with one illustrated embodiment.

FIG. 20B is a top elevational view of the wing of FIG. 20A with a spanwise flow inhibitor.

FIG. 20C is a top elevational view of the wing of FIG. 20B with gurney flaps.

FIG. 21A is a top elevational view of a wing, in accordance with one illustrated embodiment.

FIG. 21B is a top elevational view of the wing of FIG. 21A with a spanwise flow inhibitor.

FIG. 21C is a top elevational view of the wing of FIG. 21B with gurney flaps.

FIG. 22 is a flowchart showing a method of installing a gurney flap, according to one embodiment.

FIG. 23 is a top elevational view a wing with a wing tip extension.

### DETAILED DESCRIPTION OF THE INVENTION

In the following description, certain specific details are set forth in order to provide a thorough understanding of various embodiments of the invention. However, one skilled in the art will understand that the invention may be practiced without these details.

Unless the context requires otherwise, throughout the specification and claims which follow, the word “comprise” and variations thereof, such as, “comprises” and “comprising” are to be construed in an open, inclusive sense, that is as “including, but not limited to.”

The headings provided herein are for convenience only and do not interpret the scope or meaning of the claimed invention. The following description relates to lift-generating elements of an aircraft. The lift-generating elements, such as wings, can have at least one fixed gurney flap for altering the pressure distribution along the lift-generating element. These gurney flaps can be positioned at a trailing edge region of the lift-generating element to increase lift during flight. For purposes of this description and for clarity, an aircraft will be described and then a description of gurney flaps, spanwise flow inhibitors, pressure distributions, and methods of installing gurney flaps will follow. The gurney flaps are disclosed in the context of wings of powered airplanes because they have particular utility in this context. However, the gurney flaps can be used in other contexts, such as, for example, but without limitation, helicopters, gliders, sailplanes, and for other vehicles in which aerodynamics is a significant consideration. Terms, such as “fore,” “aft,” “inboard,” “inward,” “outboard,” “outward,” “right,” and “left” are used to describe the illustrated embodiments and are used consistently with the description of non-limiting exemplary applications. It will be appreciated, however, that the illustrated embodiments can be located or oriented in a variety of desired positions.

### Overview of Aircraft

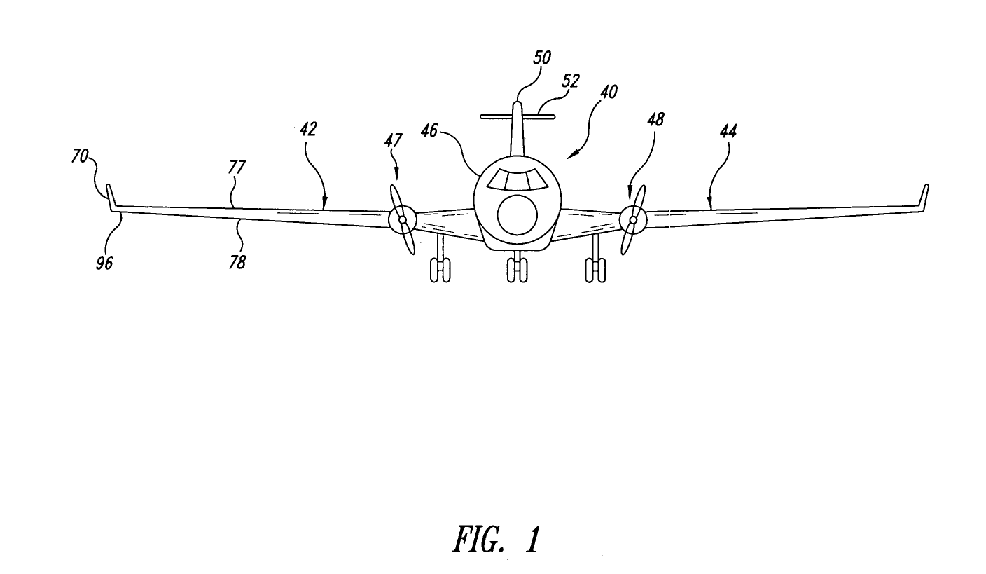

FIG. 1 shows an aircraft 40 including a pair of wings 42, 44 that extend laterally outward from opposing sides of a fuselage 46. The wings 42, 44 provide lift as the aircraft 40 travels through the air. The wings 42, 44 can be generally similar to each other and, accordingly, the following description of one of the wings applies equally to the other, unless indicated otherwise.

Propeller systems 47, 48 are mounted to the wings 42, 44, respectively. Each of the propeller systems 47, 48 has an engine that drives a propeller. Vertical and horizontal stabilizers 50, 52 control the yaw and pitch, respectively, of the aircraft 40. The vertical stabilizer 50 is interposed between the horizontal stabilizers 52 and can have a rudder to change the yaw. The horizontal stabilizers 52 have elevators to change the pitch.

FIG. 2 shows the right wing 42 including a main wing assembly 60 having a leading edge 64 and a trailing edge 66. The leading and trailing edges 64, 66 extend outwardly from the fuselage 46 to a spanwise flow inhibitor 70 in the form of a winglet. An inner portion 71 of the wing 42 is coupled to the fuselage 46.

The main wing assembly 60 includes a wing main body 74 and a control surface system 76 for controlling the flight of the aircraft 40. The main body 74 has an upper surface 77 and a lower surface 78 (see FIG. 1) opposing the upper surface 77. The upper and lower surfaces 77, 78 are shaped and dimensioned to provide lift.

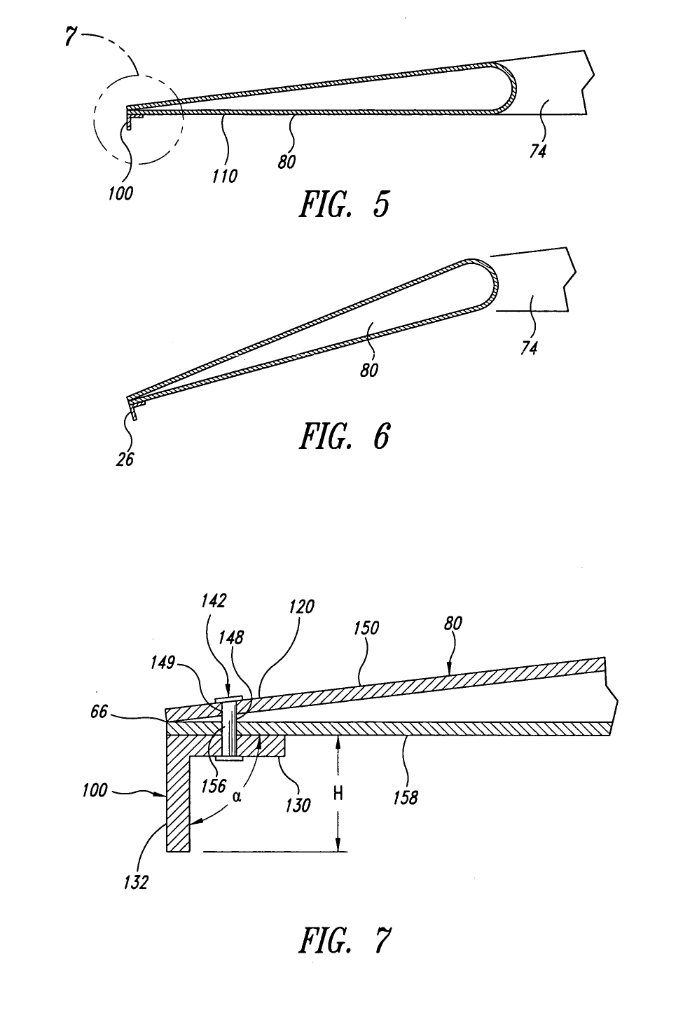

With reference to FIGS. 2 to 4, the control surface system 76 includes a movable inboard control surface 80 and a movable outboard control surface 82. Each of the illustrated control surfaces 80, 82 rotate (e.g., downwardly and upwardly) relative to the wing main body 74 for selectively increasing and/or decreasing lift. FIGS. 5 and 6 show the control surface 80 in a neutral position and lowered position, respectively. In some embodiments, the control surfaces 80, 82 can also slide forwardly and rearwardly relative to the wing main body 74. In some non-limiting embodiments, the control surfaces can be plain wing flaps, Fowler wing flaps, slotted wing flaps, split wing flaps, or other types of suitable wing flaps.

With reference again to FIGS. 2 to 4, an aileron 90 of the control surface system 76 can be actuated to maneuver the aircraft 40. In some embodiments, the ailerons of the wings 42, 44 can be moved in opposite directions for roll control about a longitudinal axis 92 (FIG. 2) of the aircraft 40. The aileron 90 of the wing 42, for example, can be actuated upwardly while the aileron of the wing 44 can be actuated downwardly. In the illustrated embodiments, the aileron 90, control surfaces, 80, 82, and wing main body 74 cooperate to form the trailing edge 66.

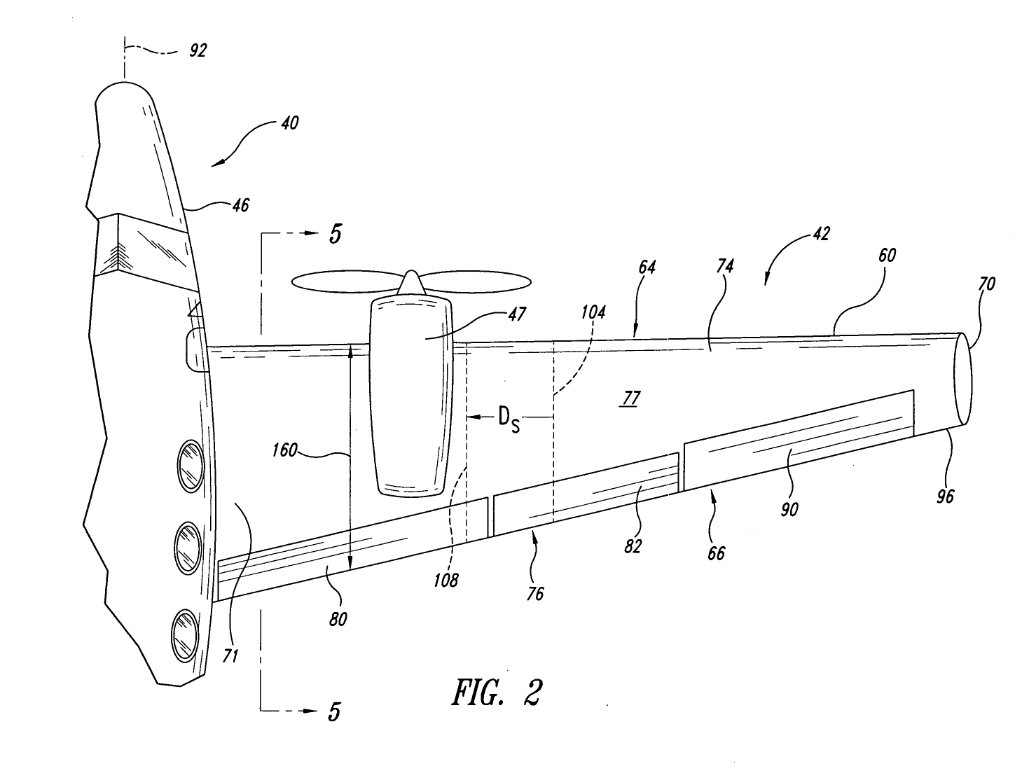

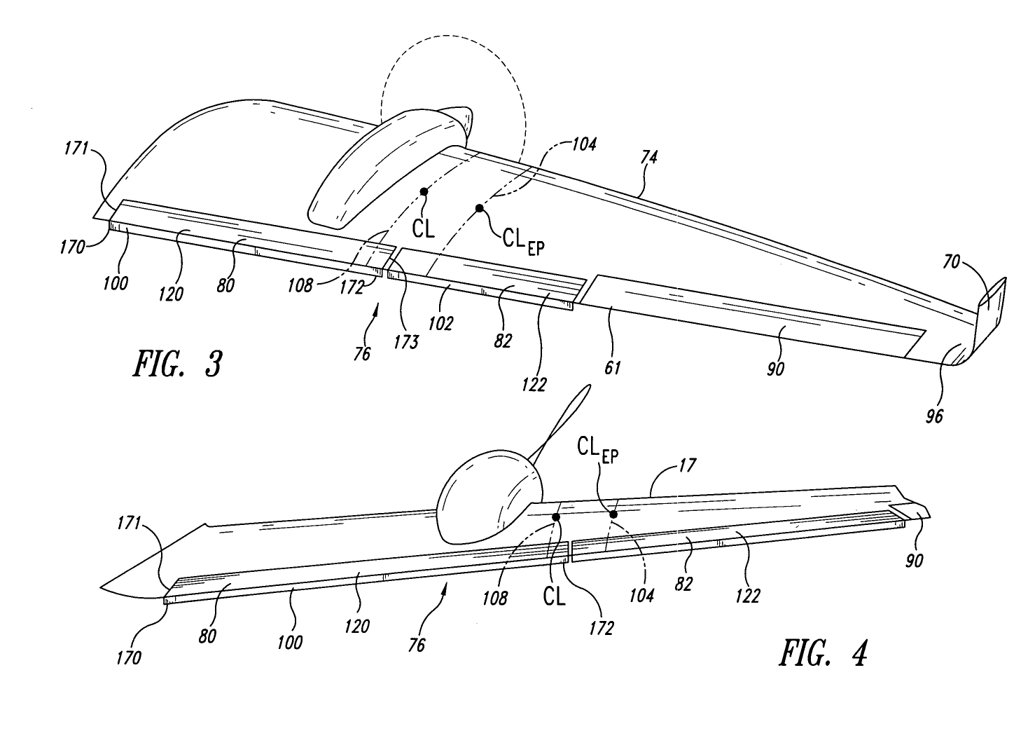

As shown in FIGS. 1 and 3, the wing 42 includes the spanwise flow inhibitor 70 for increasing the effective aspect ratio of the wing 42. The illustrated spanwise flow inhibitor 70 extends from an outer tip 96 of the main body 74. The size and shape of the spanwise flow inhibitor 70 can be selected to achieve the desired increased effective aspect ratio of the wing 42. As discussed below, various types of spanwise flow inhibitors can be used with the wing 42.

With continued reference to FIGS. 3 and 4, the wing 42 has gurney flaps 100, 102 for changing the pressure distribution along the wing 42 during flight. The illustrated downwardly extending gurney flaps 100, 102 can be positioned and configured to increase the lift along the inward portion 71 of the wing 42, thereby altering the location of the center of lift (i.e., the center of pressure) of the wing 42. The illustrated gurney flaps 100, 102 are coupled to the control surfaces 80, 82, respectively.

The broken line 104 indicates the lateral location of the center of lift of the wing 42 without the gurney flaps 100, 102 (i.e., the center of lift CL_{EP} corresponds to the center of lift of the wing 42 if the gurney flaps 100, 102 were removed) during normal flight conditions. The broken line 108 indicates the lateral location of the center of lift CL of the wing 42 with the gurney flaps 100, 102. The illustrated broken lines 104, 108 refer to the center of lifts CL_{EP}, CL, respectively, under similar flight conditions. Of course, the location of the center of lift of the wing 42 can change based on flight conditions, such as the orientation of the wing (e.g., the angle of attack), altitude of aircraft, etc.

The gurney flaps 100, 102 can at least partially counteract a change in center of lift attributable to the spanwise flow inhibitor 70. The change in the center of lift can cause increased stresses (e.g., bending stresses). The gurney flaps 100, 102 can reduce, minimize, or substantially eliminate stresses attributable to the presence of the spanwise flow inhibitor 70.

In some embodiments, the gurney flaps 100, 102 cause the center of lift CL to be at the location 108. The moment arm between the fuselage 46 and center of lift CL at location 108 is less than the moment arm between the fuselage 46 and the center of lift CL_{EP} at the location 104. In other words, the gurney flaps 100, 102 can cause the center of lift of the wing 42 to be positioned inwardly, thereby reducing the moment arm. This smaller moment arm results in smaller bending moments and, thus, improves fatigue performance of the wing 42.

FIGS. 3 and 4 show the gurney flap 100 fixedly mounted to a trailing edge region 120 of the control surface 80. The gurney flap 102 is likewise fixedly mounted to trailing edge region 122 of the control surface 82. The trailing edge regions 120, 122 each form a portion of the trailing edge 66.

The illustrated aircraft 40 is an airplane. As used herein, the term “airplane” is a broad term and includes, without limitation, an aircraft having one or more fixed wings (during flight) from which it derives most of its lift. For example, the airplane can be a fixed-wing monoplane, as illustrated in FIG. 1. Further, one or more jets, propeller systems, or other suitable propulsion systems can drive the airplane. In other embodiments, the aircraft can be a glider, sailplane, or other heavier than air flight vehicle. The gurney flaps disclosed herein can also be used with other types of aircraft. For example, the gurney flaps can be installed on helicopters. Thus, the illustrated aircraft 40 merely exemplifies one type of aircraft that may be used with some embodiments of the gurney flaps.

### Gurney Flaps

As used herein, the term “gurney flap” is a broad term and includes, without limitation, an elongate member, tab, flange, other suitable structure for placement on the pressure side (lower side) of an airfoil to generate lift when fluid flows around the trailing edge. The gurney flap, for example, can be dimensioned to increase lift without appreciably increasing parasitic drag. In some embodiments, the gurney flap can be a flap that is generally perpendicular to the lower surface 78 of the wing 42. The gurney flaps 100, 102 can be generally similar to each other and, accordingly, the following description of one of the gurney flaps applies equally to the other, unless indicated otherwise.

The gurney flap 100 of FIGS. 2 and 3 can extend along a substantial portion of the length of the control surface 80. An inner portion 170 of the gurney flap 100 is proximate an inboard edge 171 of the control surface 80. The outboard portion 172 of the gurney flap 100 is proximate an outboard edge 173 of the control surface 80. In some embodiments, the gurney flap 100 has a length that is at least about 90%, 80%, 60%, or 50% of the length of the control surface 80. Additionally, the gurney flap 100 can extend generally parallel to the trailing edge 66.

The illustrated gurney flap 100 of FIG. 7 includes a mounting portion 130 and an gurney flap main body 132 extending from the mounting portion 130. Generally, the mounting portion 130 is coupled to the wing 42. The illustrated gurney flap main body 132 extends outwardly a sufficient distance from the trailing edge region 120 of the control surface 80 to appreciably affect the airflow over the wing 42 to produce lift during flight. In some embodiments, the gurney flap 100 can cause a pressure gradient along the bottom of the wing to inhibit or substantially prevent separation of the airflow, even at greater angles of attack. Accordingly, the gurney flap 100 provides increased lift and greater angles of attack for improved maneuverability.

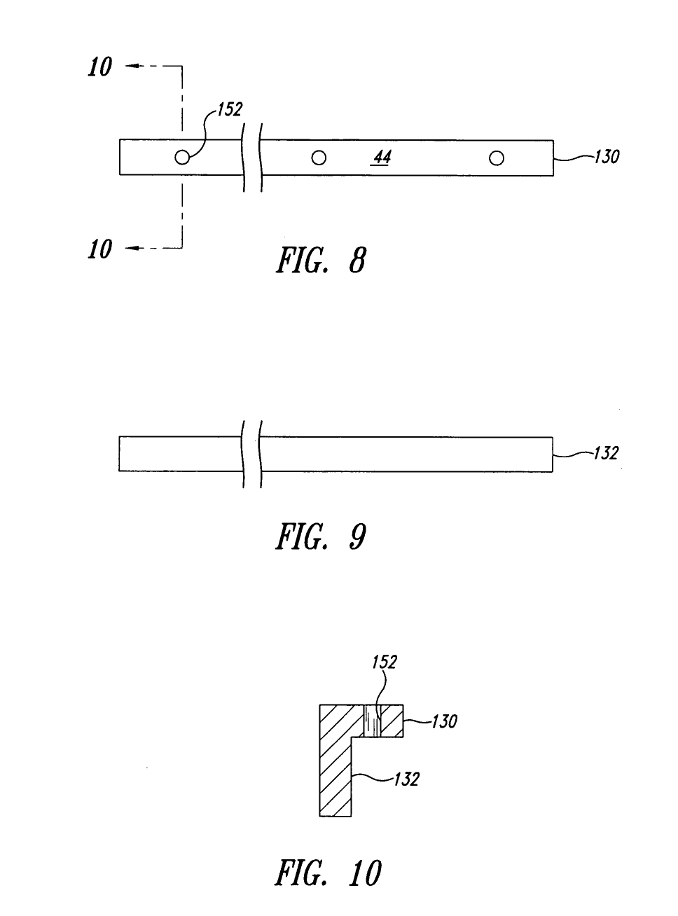

One or more fasteners (e.g., nut and bolt assemblies, rivets, and the like), welds, bonding agents, adhesives, or other attachment means can be used to temporarily or permanently couple the mounting portion 130 to the control surface 80. A plurality of spaced apart rivets can securely couple the gurney flap 100 to the control surface 80. In the illustrated embodiment of FIG. 7, a rivet 142 rigidly couples the mounting portion 130 to the control surface 80. A body 148 of the rivet 142 extends through a hole 149 in an upper surface 150 of the control surface 80, a hole 156 in a bottom surface 158 of the surface 80, and a hole 152 (see FIGS. 8 and 10) in the mounting portion 130. To install the gurney flap 100, the mounting portion 130 can be positioned along the control surface 80. For example, the holes 149, 152, 156 can be aligned. The rivet 142 can then be installed in the holes 149, 152, 156. Even though the gurney flap 100 is fixedly coupled to the surface 80, the gurney flap 100 may flex or move slightly with respect to the surface 80.

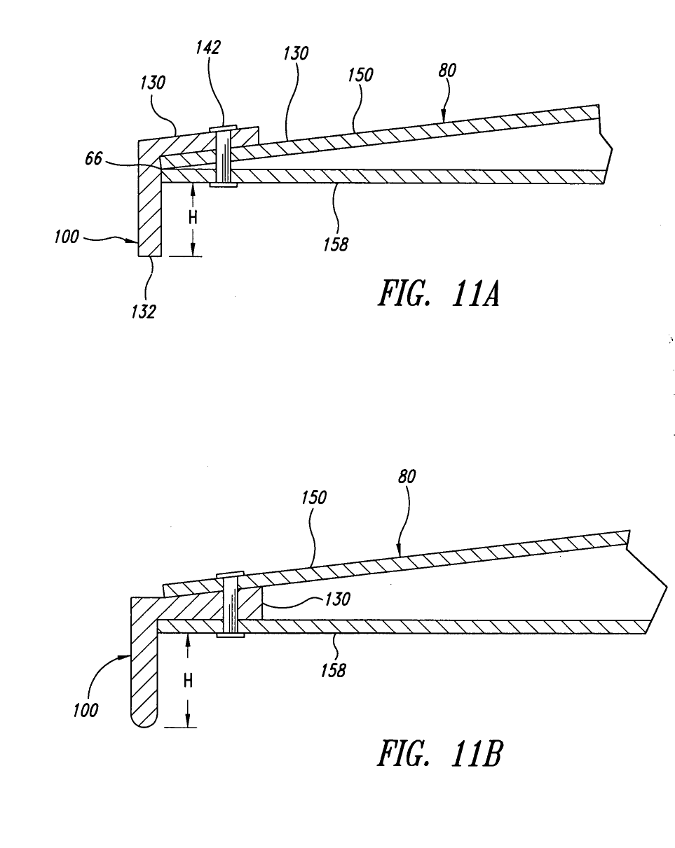

The illustrated gurney flap 100 extends downwardly from the trailing edge 66 and is generally perpendicular to the lower surface 158 of the surface 80. The gurney flap 100 can also be at other locations. For example, FIG. 11A shows the mounting portion 130 positioned on top of the surface 80. The lower surface of the mounting portion 130 rests upon the upper surface 150 of the surface 80. The trailing edge 66 of the surface 80 is position at the junction of the mounting portion 130 and gurney flap main body 132, which extends downwardly beyond the trailing edge 66.

FIG. 11B shows the mounting portion 130 of the gurney flap 100 sandwiched between the upper surface 150 and lower surface 158 of the surface 80. Advantageously, the mounting portion 130 of the gurney flap 100 can frictionally interact with the upper and lower surfaces 150, 158 to minimize or substantially prevent movement of the mounting body 130 relative to the surface 80.

As shown in FIGS. 7, 11A, and 11B, the gurney flap main body 132 can be generally perpendicular to the lower surface 158 of the surface 80. The main body 132 can also be at other orientations with respect to the surface 80. With reference again to FIG. 7, the angle α (defined between the main body 132 and the lower surface 158 of the wing 42) can be in the range of about 70 degrees to about 110 degrees. In some embodiments, the angle α is in the range of about 85 degrees to about 95 degrees. The orientation of the main body 132 can be selected based on the desired lift and an acceptable amount of parasitic drag, for example.

The gurney flap 100 can also be spaced fore or aft of the trailing edge 66. For example, the gurney flap 100 can be mounted fore of the trailing edge 66. The distance between the gurney flap 100 and trailing edge 66 can be selected based on the desired airflow over the control surface 80. Thus, the gurney flap 100 can be at various positions along a lift-generating element.

The gurney flaps 100 of FIGS. 7, 11A, and 11B extend a height H into the boundary layer of the airflow over the lower surface 158 of the control surface 80. The height H can be selected to achieve the desired ratio of increase in lift to increase in drag. For example, the height H can be equal to or less than about 1% or 2% of the chord 160 (FIG. 2) of the wing 42, where the chord 160 is taken along the portion of the wing 42 in front of the gurney flap 100. In such embodiments, the gurney flap 100 may produce appreciable lift with an insignificant amount of drag. The gurney flap 100 can have a height H that is greater than about 2%, 3%, or 4% of the chord 160 for enhanced lift, but the flap 100 may produce a substantial amount in drag. In some circumstances, this drag may be acceptable. The dimensions of the gurney flap 100 can therefore be selected based on the desired lift taking into account drag.

The gurney flap 100 can have a uniform or non-uniform height. In some embodiments, including the illustrated embodiment of FIGS. 3 and 4, the gurney flap 100 has a generally uniform height along its length. Thus, the heights of the inner portion 170 and outer portion 172 of the gurney flap 100 can be generally equal to each other.

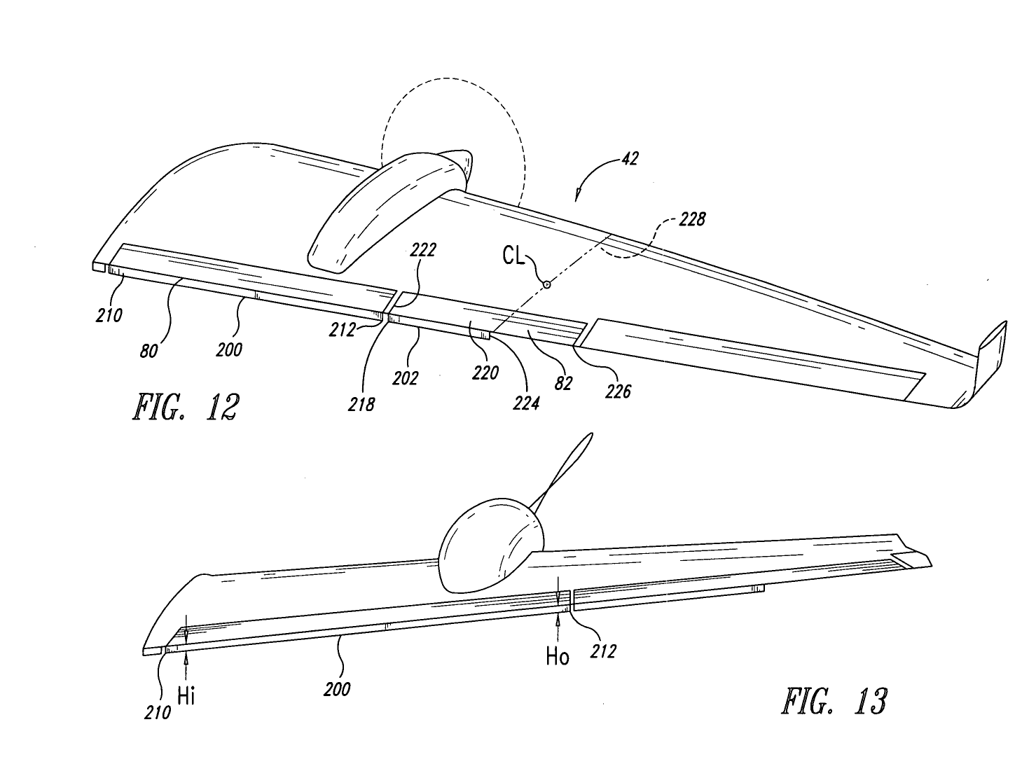

FIGS. 12 and 13 show gurney flaps 200, 202 having non-uniform heights. In the illustrated embodiments, the gurney flaps 200, 202 are decreased in height in the outboard direction. As shown in FIG. 13, the gurney flap 200 has a height Hᵢ at the inner portion 210 and a height Hₒ at an outer portion 212, where the height Hᵢ is greater than the height Hₒ. The inner portion 210 advantageously provides greater lifting forces as compared to the outer portion 212, thus moving the center of lift CL further inwardly.

The height H of the gurney flap 200 can gradually decrease along the length of the control surface from the height Hᵢ to height Hₒ. Similarly, the gurney flap 202 coupled to the surface 82 can have a height that decreases in the outboard direction. In such embodiments, the lift provided by the gurney flaps 200, 202 is decreased in the outboard direction, thus further moving the center of lift towards the fuselage 46.

The gurney flap 202 extends along a portion of a trailing edge region 220 of the surface 82. An inner portion 218 of the gurney flap 202 is proximate an inboard edge 222 of the surface 82. An outer portion 224 of the gurney flap 202 is at a desired location between the inboard and outboard edges 222, 226 of the surface 82. In the illustrated embodiment, the outer portion 224 of the gurney flap 202 is at or near the lateral position 228 of the center of lift CL. That is, the distance between the outer portion 224 of the gurney flap 202 and the fuselage can be similar or equal to the distance between the fuselage and the center of lift CL. Thus, the gurney flaps 200, 202 increase the pressure on the lower surface of the wing 42 positioned inboard of the center of lift CL.

The gurney flaps disclosed herein may be formed through any suitable means. For example, the gurney flaps can be formed through molding (e.g., injection molding), machining, extruding, and/or bending processes. Relatively inexpensive gurney flaps can be formed by cutting an extruded angled member. The flaps can also be formed by bending an extruded sheet of metal (e.g., aluminum) into the desired shape. After installing the gurney flaps, the gurney flaps can be repositioned (e.g., bent forwardly or rearwardly) to adjust the amount of generated lift. Accordingly, gurney flaps can be adjusted any number of times to change the performance of the wing.

### Spanwise Flow Inhibitors

As used herein, the term “spanwise flow inhibitor” is a broad term and can include, but is not limited to, one or more structures (e.g., wingtip fences, winglets, endplates, airfoils, tip sails, and the like) extending from a wing that limit, minimize, or substantially prevent spanwise airflow along at least a portion of a wing. The spanwise flow inhibitor can be a wingtip spanwise flow inhibitor extending from a wingtip. In some embodiments, the spanwise flow inhibitors increase the effective aspect ratio of the wing. In some embodiments, as noted above, the spanwise flow inhibitor can be a wingtip fence or winglet that can increase the effective aspect ratio of the wing without appreciably increasing the span of the wing. The orientations of the spanwise flow inhibitors can be selected to achieve the desired aerodynamics. Wing fences, winglets, endplates, tip sails, and other spanwise flow inhibitors for reducing wingtip vortices can be generally parallel to the chord of the wing to which they are attached. It is noted that spanwise flow inhibits can also be coupled at locations on other types of aircraft.

Spanwise flow inhibitors can have a one-piece or multi-piece construction. The illustrated spanwise flow inhibitor 70 of FIGS. 1 to 3 is integrally formed with the wing main body 74. In other embodiments, the spanwise flow inhibitor 70 is a separate component that is coupled to the tip 96. For example, the spanwise flow inhibitor 70 can be an aftermarket retrofit that effectively enhances performance and fuel efficiency for older model aircraft. These aftermarket spanwise flow inhibitors allow re-optimization of wings based on desired handling characteristics, fuel efficiency, loading capacities, and other criteria known in the art. Often, the modification of a wing made by the original equipment manufacturer (OEM) with an aftermarket spanwise flow inhibitor changes the stresses on the wing 42 during flight. As discussed above, spanwise flow inhibitors can result in increased bending stresses that may increase the rate of crack formation, crack growth, and the like. This can lead to the incurred additional costs associated with more frequent inspections and part replacement/maintenance. Advantageously, the gurney flaps can be utilized to limit, minimize, or substantially prevent an increase in applied stresses in the wing 42 attributable to the spanwise flow inhibitor.

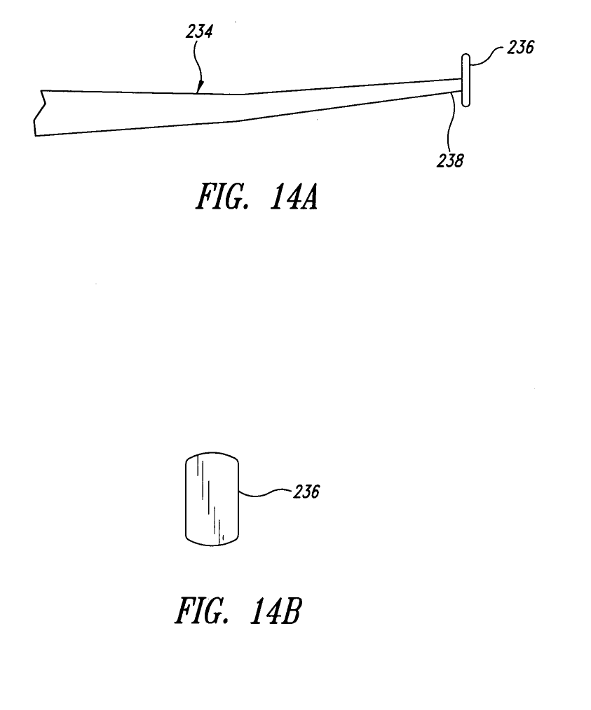

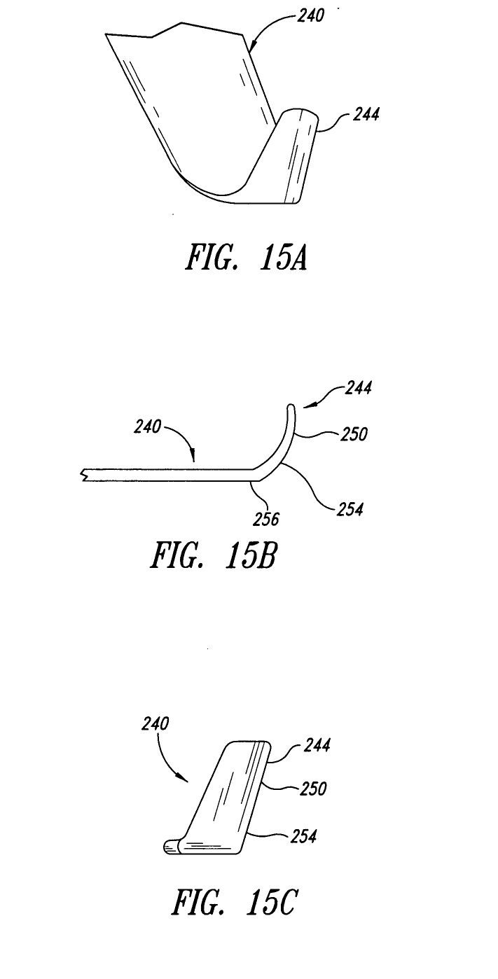

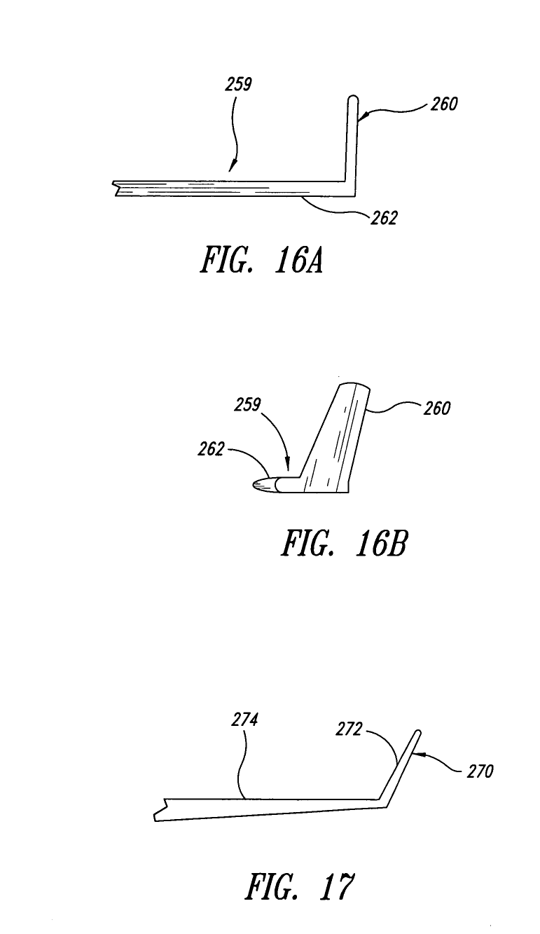

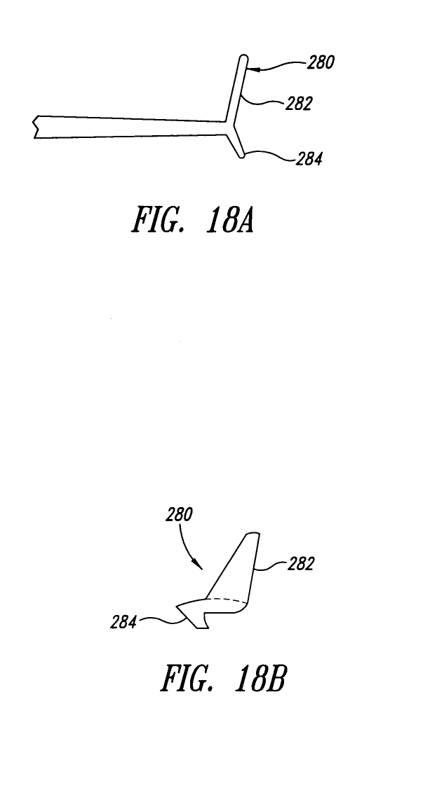

FIGS. 14A to 18B show spanwise flow inhibitors that can be used with the fixed gurney flaps, in accordance with some embodiments. FIG. 14A shows a wing 234 including a vertical endplate 236 that extends upwardly and downwardly from a wingtip 238. FIGS. 15A to 15C show a wing 240 with a blended winglet 244. The winglet 244 has a somewhat straight section 250 and a curved transition section 254 connecting the straight section 250 to a wingtip 256. The blended winglet 244 can result in improved aerodynamic loading as compared to traditional spanwise flow inhibitors. FIGS. 16A to 16B show a wing 259 with an upwardly extending winglet 260 that is generally perpendicular to the wing main body 262. The winglet 260 is especially well suited for retrofitting because of its ease of installation. FIG. 17 shows an angled winglet 270 that has a generally straight section 272 angled and connected to a wing main body 274. FIGS. 18A and 18B show a spanwise flow inhibitor 280 having a plurality of tip sails 282, 284. The illustrated spanwise flow inhibitor 280 has the upper tip sail 282 that extends upwardly and outwardly. The lower tip sail 284 is positioned fore of the upper tip sail 282 and extends downwardly and outwardly. The tip sails 282, 284 can each be a tapered fin, small winglet, or other type of small spanwise flow inhibitor. The number and orientation of the tip sails can be selected to achieve the desired performance characteristics, such as reduced induced drag. The spanwise flow inhibitor area, toe-out, span, lifting characteristics, sweep angle, cant angle, and/or ratio of spanwise flow inhibitor root chord to tip chord can be selected to achieve the desired aircraft performance.

### Pressure Distributions

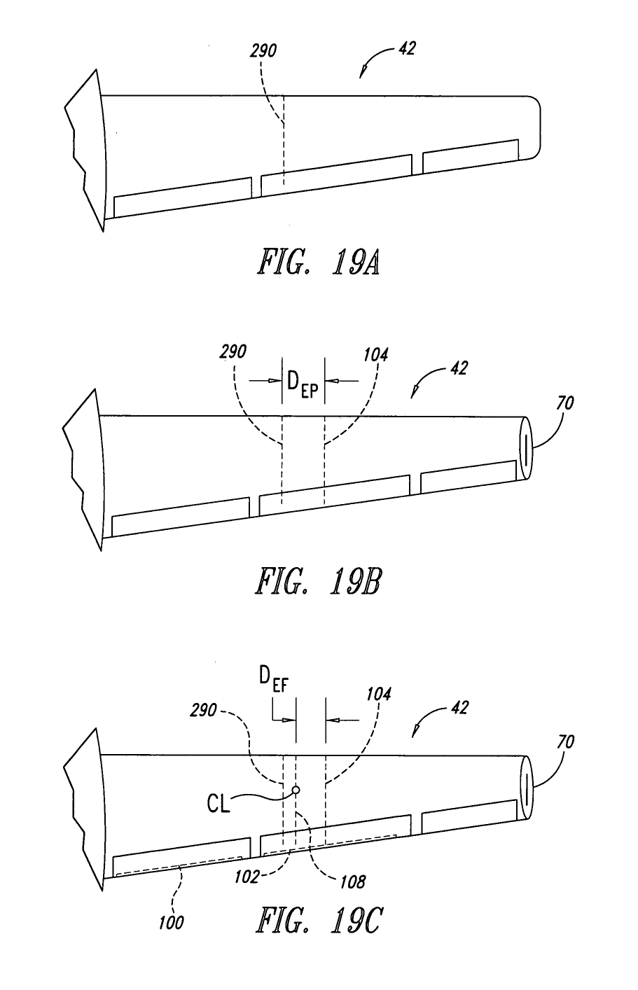

The gurney flaps described herein can be used to achieve the desired pressure distributions on wings. FIGS. 19A to 21C show some advantages of using gurney flaps. As noted above, the gurney flaps can serve to counteract at least some of the larger stresses (e.g., bending stresses due to large bending moments) attributable to the presence of spanwise flow inhibitors. Generally, a wing with fixed gurney flaps and an spanwise flow inhibitor can have a center of lift located between a first distance and second distance from the fuselage, wherein the first distance is the location of center of lift resulting in part due to the spanwise flow inhibitor and the second distance resulting in part due to the presence of the gurney flap, and the first distance is greater than the second distance, as detailed below.

FIG. 19A shows the wing 42 where both the spanwise flow inhibitor 70 and fixed gurney flaps 100, 102 have been removed. A broken line 290 indicates the lateral location of the center of lift of the main body 74 itself. FIG. 19B shows the location 104 of the center of lift of the wing 42 with the spanwise flow inhibitor 70 but without the gurney flaps 100, 102. The spanwise flow inhibitor 70 causes the center of lift to be positioned outwardly a distance D_{EP}. Thus, the moment arm is increased by the distance D_{EP}. FIG. 19C shows the wing 42 with both the spanwise flow inhibitor 70 and gurney flaps 100, 102 (shown in phantom). The gurney flaps 100, 102 cause the center of lift CL to be positioned inwardly at the location 108, which is a distance D_{EF} from the location 104. The distance D_{EF} is less than the distance D_{EP}. Thus, the moment arm of the wing 42 of FIG. 19C is greater than the moment arm of the wing 42 of FIG. 19A but less than the moment arm of the wing 42 of FIG. 19B.

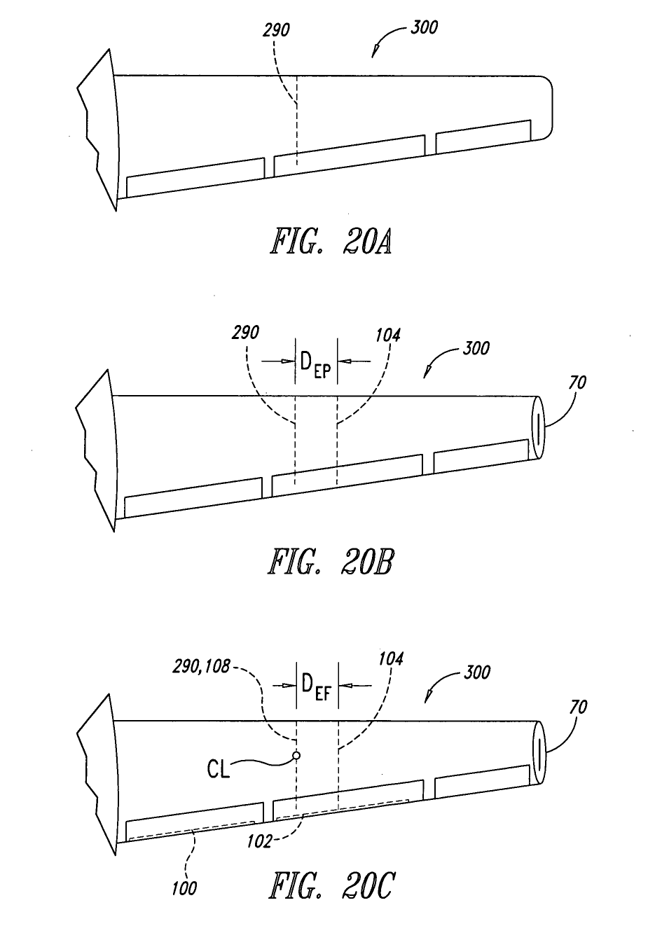

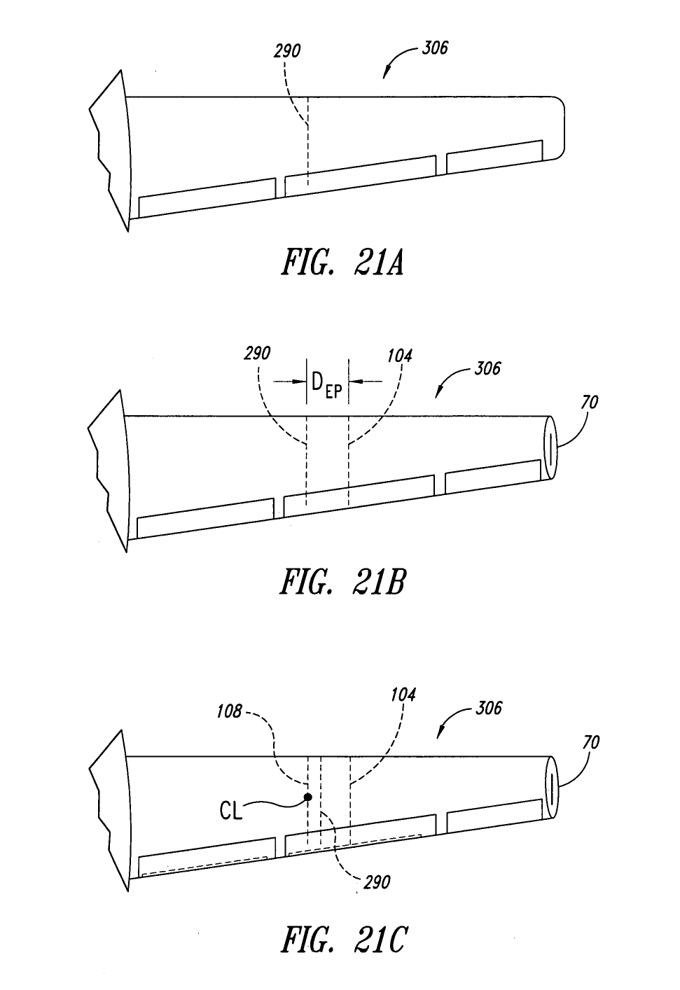

FIGS. 20A to 21C show a wing 300 that is generally similar to the wing 42 of FIGS. 19A to 19C, except as detailed below. The gurney flaps 100, 102 of FIG. 20C cause the center of lift CL to be positioned at location 108, which is located inboardly of the location 104. In the illustrated embodiment, the location 108 is near or at the location 290. Thus, the gurney flaps 100, 102 act to minimize or substantially eliminate changes in the moment arm due to the spanwise flow inhibitor 70.

FIGS. 21A to 21C show a wing 306 that is generally similar to the wing 42 of FIGS. 19A to 19C, except as detailed below. The gurney flaps 100, 102 of FIG. 21C cause the center of lift CL to be positioned at location 108, which is located inboardly of the location 290. Thus, the gurney flaps 100, 102 cause the moment arm of the wing 306 with the spanwise flow inhibitor 70 to be less than the moment arm of the wing 306 of FIG. 21A. The number, size, position, and dimensions of the gurney flaps can be selected to provide the desired counteraction of the change in center of lift attributable to the spanwise flow inhibitor 70.

### Methods of Installation

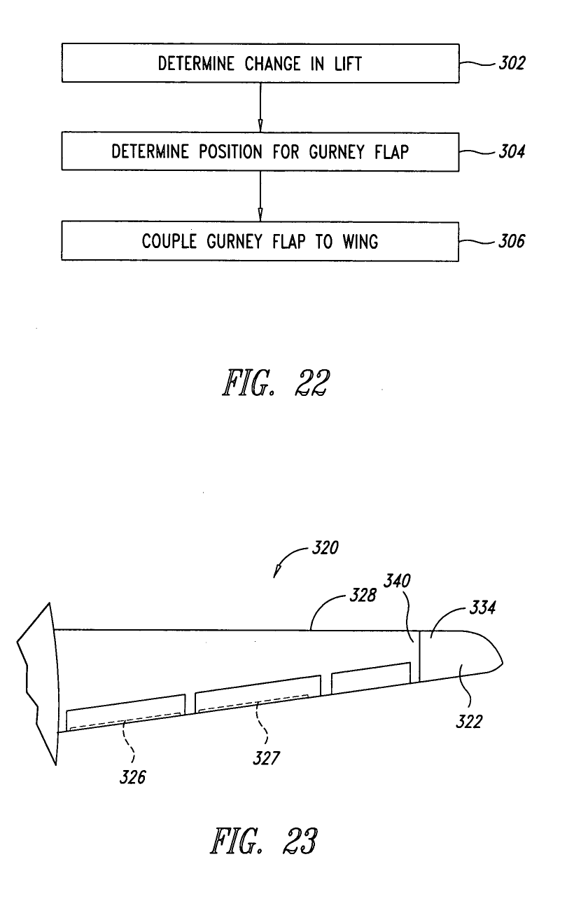

FIG. 22 shows a method of installing a gurney flap, according to one embodiment. As 302, a change in a position of a center of lift of a wing attributable to a spanwise flow inhibitor is determined. The changed can be determined by using simulations (e.g., computer simulations), theoretical methods, experimental methods, combinations thereof, and the like. At 304, a longitudinal position along a trailing edge of a wing is determined such that lift produced by a gurney flap counters the change in the position of the center of lift attributable to the spanwise flow inhibitor. At 306, the gurney flap is coupled to extend from a portion of the trailing edge at the determined longitudinal position. In this manner, any number of gurney flaps can be installed on the wing.

The gurney flaps disclosed herein can be coupled to various suitable locations of an aircraft. For example, the gurney flaps can be mounted near or at trailing edges of the horizontal stabilizers, elevators, lift-generating elements, and other movable or non-movable surfaces of the aircraft. The location and orientation of the gurney flaps can be selected based on the desired aerodynamics of the aircraft. For example, gurney flaps can be used on wings (e.g., rotating wings, rotors, and the like) of a helicopter.

Other Types of Wings with Gurney Flaps

The gurney flaps can also be mounted to other types of wings to reduce bending moments. Many types of wing modifications can increase bending moments. For example, wing extensions, such as wing tip extensions, can increase bending moments. As used herein, the term “wing tip extension” is a broad term and may include, without limitation, an extension designed for mounting to a wing to increase the wing's span. In some embodiments, the wing tip extension can appreciably increase the span of the wing. The wing tip extension, in some non-limiting embodiments, can increase the span of the wing more than about 1%, 3%, 5%, 10%, and ranges encompassing such percentages. The gurney flaps can be used to offset the change in center of lift attributable to the modification.

FIG. 23 shows a wing 320 with a wing extension 322 in accordance with one embodiment. Gurney flaps 326, 327 are mounted to a main body 328 of the wing 320. An inward portion 334 of the wing extension 322 is fixedly coupled to the outward portion 340 of the main body 328. Various types of wing extensions with different profiles can be attached to traditional wings.

Various methods and techniques described above provide a number of ways to carryout the invention. Of course, it is to be understood that not necessarily all objectives or advantages described may be achieved in accordance with any particular embodiment described herein. Thus, for example, those skilled in the art will recognize that the methods may be performed in a manner that achieves or optimizes one advantage or group of advantages as taught herein without necessarily achieving other objectives or advantages as may be taught or suggested herein.

Furthermore, the skilled artisan will recognize the interchangeability of various features from different embodiments disclosed herein. Similarly, the various features and steps discussed above, as well as other known equivalents for each such feature or step, can be mixed and matched by one of ordinary skill in this art to perform methods in accordance with principles described herein. For example, the gurney flaps can be coupled to swept wings, elliptical wings, swing wings, straight wings, flying wings (e.g., the wings of a B-35 airplane), and other wing designs. Additionally, the methods which are described and illustrated herein are not limited to the exact sequence of acts described, nor are they necessarily limited to the practice of all of the acts set forth. Other sequences of events or acts, or less than all of the events, or simultaneous occurrence of the events, may be utilized in practicing the embodiments of the invention.

Although the invention has been disclosed in the context of certain embodiments and examples, it will be understood by those skilled in the art that the invention extends beyond the specifically disclosed embodiments to other alternative embodiments and/or uses and obvious modifications and equivalents thereof. Accordingly, it is not intended that the invention be limited, except as by the appended claims.

What is claimed is:

1. An aircraft comprising:
a fuselage;
a wing extending laterally outward from the fuselage, the wing having an inner portion proximate the fuselage, an outer wingtip, and at least a first selectively movable control surface spaced between the inner portion and the outer wingtip, a portion of the wing forming a leading edge between the inner portion and the outer wingtip and a portion of the wing forming a trailing edge between the inner portion and the outer wingtip;
a spanwise flow inhibitor extending at an angle from the outer wingtip of the wing; and
at least one gurney flap extending generally downwardly from at least a portion of the trailing edge of the wing.

2. The aircraft of claim 1 wherein the at least one gurney flap is dimensioned to generate lift on a portion of the wing between a center of lift of the wing and the fuselage when the aircraft is in flight.

3. The aircraft of claim 1 wherein the gurney flap is sized, dimensioned, and positioned to at least partially counteract a change in center of lift attributable to the spanwise flow inhibitor.

4. The aircraft of claim 1 wherein the gurney flap is sized, dimensioned, and positioned to approximately offset a change in center of lift attributable to the spanwise flow inhibitor.

5. The aircraft of claim 1 wherein the at least one gurney flap has an elongate portion that is fixed to and extends substantially perpendicular from a lower surface of the at least one control surface.

6. The aircraft of claim 1 wherein the at least one gurney flap extends longitudinally along a substantial portion of a rearward portion of the at least one control surface, the rearward portion of the at least one control surface forming at least a portion of the trailing edge of the wing.

7. The aircraft of claim 1 wherein the at least one gurney flap has a height that decreases in an outwardly direction towards the outer wingtip.

8. The aircraft of claim 1 wherein the at least one gurney flap is a flange.

9. The aircraft of claim 1 wherein the at least one control surface is a flap and the gurney flap extends from a portion of the flap.

10. The aircraft of claim 1 wherein the at least one control surface is an aileron and the gurney flap extends from a portion of the aileron.

11. The aircraft of claim 1 wherein the at least one control surface includes a flap and an aileron, and wherein the gurney flap extends from a fixed portion of the trailing edge spaced between the flap and the aileron.

12. A wing for an airplane, the wing comprising:
a wing assembly comprising a main body and at least one selectively movable control surface, the main body having an outer wingtip, an upper surface, and a lower surface opposing the upper surface, the upper and lower surfaces are shaped and dimensioned to produce lift during flight;
a spanwise flow inhibitor coupled to the outer wingtip of the main body; and
at least one gurney flap fixedly extending at an angle from and longitudinally along a portion of the wing proximate the trailing edge thereof.

13. The wing of claim 12 wherein when the wing is mounted to a fuselage of the airplane, the wing has a center of lift when in flight located between a first distance from the fuselage and second distance from the fuselage, the first distance is a first location of a first center of lift resulting in part due to the spanwise flow inhibitor, and the second distance is a second location of a second center of lift resulting in part due to the at least one auxiliary gurney flap, wherein the first distance is greater than the second distance.

14. The wing of claim 12 wherein when the wing is mounted to a fuselage of the airplane, the spanwise flow inhibitor contributes to a bending moment of the wing in flight, and the at least one gurney flap reduces substantially the contribution of the spanwise flow inhibitor to the bending moment.

15. The wing of claim 12 wherein the at least one selectively movable control surface comprises an aileron and a wing flap movably coupled to the main body.

16. The wing of claim 15 wherein the wing flap has a trailing edge portion that defines a section of the trailing edge of the main wing assembly, and the at least one gurney flap is coupled to the trailing edge portion of the wing flap.

17. The wing of claim 12 wherein the at least one movable control surface comprises an inboard wing flap and an outboard wing flap, and the at least one gurney flap comprises a first gurney flap fixedly coupled to the inboard wing flap and a second gurney flap fixedly coupled to the outboard wing flap.

18. The wing of claim 12 wherein the at least one gurney flap extends along most of the trailing edge of the main wing assembly extending inboardly of a center of pressure of the wing.

19. The wing of claim 12 wherein a substantial portion of the at least one gurney flap is positioned inwardly of a center of lift of the wing.

20. The wing of claim 12 wherein the at least one selectively movable control surface has a trailing edge portion that defines a portion of the trailing edge of the main wing assembly, and the at least one gurney flap is coupled to the trailing edge portion.

21. A wing for an aircraft, the wing comprising:
a cambered upper surface;
a cambered lower surface;
at least one selectively movable control surface;
a leading edge formed between the upper and the lower surfaces;
a trailing edge formed between the upper and the lower surfaces, the trailing edge including a portion of the at least one control surface;
an outer wingtip;
a spanwise flow inhibitor extending at an angle from at least proximate the outer wingtip; and
means for offsetting a change in a center of lift attributable to the spanwise flow inhibitor.

22. The wing of claim 21 wherein the means for offsetting the change in center of lift includes a gurney flap extending from proximate the trailing edge of the wing.

23. The wing of claim 22 wherein the gurney flap extends from a portion of the wing between an inner portion of the wing and a position of the center of lift of the wing without the gurney flap.

24. The wing of claim 22 wherein the gurney flap extends from the at least one control surface of the wing.

25. A method of installing a gurney flap on a wing of an aircraft, the method comprising:
determining a change in a position of a center of lift attributable to a spanwise flow inhibitor;
determining a longitudinal position along a trailing edge of a wing such that lift produced by a gurney flap counters the change in the position of the center of lift attributable to the spanwise flow inhibitor; and
coupling the gurney flap to extend from a portion of the trailing edge at the determined longitudinal position.

26. The method of claim 25 wherein determining the longitudinal position along the trailing edge of the wing such that lift produced by the gurney flap counters the change in the position of the center of lift attributable to the spanwise flow inhibitor includes determining an amount of lift generated by the gurney flap.

27. The method of claim 25 wherein coupling the gurney flap to extend from the portion of the trailing edge at the determined longitudinal position includes fixedly coupling the gurney flap to a movable control surface of the wing.

28. The method of claim 25 wherein coupling the gurney flap to extend from the portion of the trailing edge at the determined longitudinal position includes fixedly coupling the gurney flap between an inner portion of the wing and a movable control surface of the wing.

29. The method of claim 25 wherein coupling the gurney flap to extend from the portion of the trailing edge at the determined longitudinal position includes fixedly coupling the gurney flap between an inner portion of the wing and a center of pressure of the wing without the gurney flap.

30. A wing for an airplane, the wing comprising:
a wing assembly comprising a main body and at least one selectively movable control surface, the main body having an outer wingtip, an upper surface, and a lower surface opposing the upper surface, the upper and lower surfaces are shaped and dimensioned to produce lift during flight;
a wing extension mounted to the outer wingtip of the main body; and
at least one gurney flap fixedly extending at an angle from and longitudinally along a portion of the wing proximate a trailing edge thereof.

31. The wing of claim 30, wherein the wing extension is an aftermarket retrofit wing tip extension.

32. The wing of claim 30, wherein the at least one gurney flap is sized, dimensioned, and positioned to at least partially counteract a change in center of lift of the wing attributable to the wing extension.
